(19) United States
(12) Patent Application Publication
(10) Pub. No.: US 2024/0279760 A1
(43) Pub. Date: Aug. 22, 2024

(54) METHOD FOR FORMING A FOAMY SLAG IN AN ELECTRIC ARC FURNACE

(71) Applicant: PIPEX ENERGY S.R.L., Milano (IT)

(72) Inventors: Luca OREFICI, Angera (VA) (IT); Carlo MAPELLI, Vailate (CR) (IT)

(73) Assignee: PIPEX ENERGY S.R.L., Milano (IT)

(21) Appl. No.: 18/574,086

(22) PCT Filed: Jun. 30, 2022
(86) PCT No.: PCT/IB2022/056111

§ 371 Date: Dec. 26, 2023

(30) Foreign Application Priority Data
Jul. 1, 2021 (IT) 102021000017366

(51) Int. Cl. C21C 5/54; C21C 5/52; C21C 7/00; F27D 11/08

(52) U.S. Cl. CPC C21C 5/54; C21C 5/527; C21C 7/0025; F27D 11/08; C21C 2007/0031; C21C 2200/00; C21C 2300/02

(57) ABSTRACT

A method for forming a foamy slag in an electric arc melting furnace during the production of a ferrous alloy may include: (a) melting a metal charge in the electric arc furnace to obtain a molten metal bath including a layer of a floating slag; (b) introducing a foamy slag forming agent into the furnace to foam the floating slag. The agent may be a composite material in granular form which includes at least one thermoplastic polymeric material and at least one biogenic carbonaceous material.

### FIELD OF THE INVENTION

The present invention relates to a method for forming a foamy slag in an electric arc furnace. In particular, the method according to the invention makes it possible to obtain a foamy slag with a reduced environmental impact.

### BACKGROUND OF THE INVENTION

One of the main technologies for producing ferrous alloys, particularly steel, is the Electric Arc Furnace (EAF) technology. This technology uses a metal charge comprising ferrous scrap from a wide variety of steel products that have reached the end of their lifecycle and/or other metal materials such as DRI (Direct Reduced Iron), HBI (Hot Briquetted Iron), cast iron and ferroalloys, and possibly other metal materials (ores or metal oxides) as raw material to produce new ferrous alloy products.

In the electric arc furnace, the metal charge is melted inside a crucible by the heat developed by an electric arc that is sparked between the metal charge and one or more graphite electrodes placed close to the charge. According to an alternative technology, the metal charge, after heating, is continuously fed into the crucible of the electric arc furnace where it melts as a result of both the contact with the molten metal bath and the electric arc.

At the end of the melting, the molten metal bath is subjected to a refining treatment inside the crucible to reach the desired chemical composition and finally drained from the crucible in a ladle in order to be started to the subsequent processing until the finished product is obtained.

To promote the melting process, oxygen and other fuels, such as fossil coal and/or coke, are typically introduced into the furnace to provide chemical energy to the system and reduce the high electricity consumption of the furnace. Hard coal and coke are either added coarse in size to the metal scrap charge to be melted or are injected finer in size through the perimeter injection systems with which electric arc furnaces are often provided. The gaseous oxygen, on the other hand, is injected into the molten metal bath to promote dephosphorization and decarburization of the metal bath: in fact, it reacts with the elements present, in particular iron, aluminium, silicon, manganese and phosphorus, forming corresponding oxides that migrate towards the surface of the bath where they form a floating slag layer. The slag, in addition to sequestering elements that are undesirable in the ferrous alloy, is foamed to increase the energy efficiency of the process, limit electrode consumption, and protect the refractory material of the furnace and the panels cooled by forced water circulation from direct radiation of the electric arc. In addition, the foamy slag prevents the risk that the molten metal bath incorporates the nitrogen produced by the interaction of the electric arc with the air. The foamy slag also reduces the noise pollution generated by the arc as it is triggered between the electrodes and the metal bath.

The foaming of the slag is achieved by incorporation of gas into it, which increases its apparent volume. The gas is generated in situ by injecting foamy slag forming agents, such as fossil coal and coke, into the slag or into the molten metal bath near the surface in contact with the slag. Iron oxides, in particular FeO, formed as a result of the injection of gaseous oxygen, react with the carbon of the fossil coal and coke forming metallic iron in a liquid state and gaseous carbon monoxide that makes the foamy slag. This also recovers the metallic iron which would otherwise escape from the furnace in the form of oxide with the slag. Foamy slag forming agents are injected in the form of a fine powder through one or more lances that use a gaseous stream (usually compressed air) as a vehicle for said agents.

An important limitation of the slag foaming technique, and more generally of the production of ferrous alloys in an electric arc furnace, is given by the environmental impact resulting from the use of fossil materials such as coal and coke, which generate significant amounts of carbon dioxide emissions into the atmosphere.

In order to contain the environmental impact due to these emissions, it is known in the state of the art to use polymeric materials obtained from the recovery of waste, such as plastic and rubber, as a partial or total substitution of coal and coke, both as fuels and as foamy slag forming agents. The use of these materials, however, offers the advantage of valuing waste and scrap from industrial processes or post-consumer products, but it limitedly improves the overall balance of the emissions of carbon dioxide and other climate-altering gases of the ferrous alloy production process.

In the state of the art, it is also known for the same purposes to use materials of biogenic origin, such as charcoal or other products obtained through pyrolysis or gasification of biomass (collectively referred to as “char” or “biochar” if obtained from biogenic material sourced and processed in an environmentally sustainable manner) as a substitute, at least partially, for materials of fossil origin. Biochar, being derived from renewable sources, in fact improves the overall balance of the emissions of the production process of the ferrous alloys in EAF due to the neutralization of the carbon dioxide emissions (i.e. carbon neutrality) stemming from the fact that biochar is of biogenic origin and therefore overall it produces no net emissions of climate-altering gases if obtained from the sustainable exploitation of biomass.

However, biochar, when used as a foamy slag forming agent, has several drawbacks. First of all, its effectiveness is lower than that of fossil coal and coke, due to the limited capacity of the biochar to penetrate and disperse in the slag and in the molten metal bath due to its relatively low density. Biochar is also less reactive than materials of fossil origin due to the limited wettability of its surface by the slag and molten metal. In addition, due to its low mechanical compactness, biochar can break down into fine powders, which can cause clogging problems in the pneumatic conveying systems that take the material from the storage point and transport it to the lances located near the furnace. Moreover, the poor ability of the biochar to penetrate the slag in combination with its low density and limited reactivity favours its entrainment in the fumes exiting the furnace before it can react with the slag and the molten metal bath. During handling and storage, biochar also has the tendency, again by virtue of its poor mechanical compactness, to crumble, forming additional fine light powders that easily spreads into the work environment with consequent safety problems for operators. Finally, biochar is a hygroscopic material and therefore tends to absorb atmospheric moisture. This requires the adoption of appropriate storage measures throughout the supply chain, as the introduction of an excessive water content into the furnace is to be avoided for reasons of energy efficiency, plant safety and in order not to introduce hydrogen into the metal bath.

The use of materials from waste recovery and carbon sources alternative to carbon of fossil origin in metallurgical processes in EAF furnace (electric arc furnace) is described for example in U.S. Pat. No. 8,021,458B2. U.S. Pat. No. 8,021,458B2 describes a method for foaming a slag in an electric arc furnace in which a carbon-containing polymer is used as the foamy slag forming agent, possibly in the form of a physical mixture with a second carbon source (e.g. graphite or coke). In U.S. Pat. No. 8,021,458 B2 the effectiveness of the aforementioned physical mixture was tested in the laboratory by reacting the two components in a drop tube furnace and analysing the resulting carbonaceous residue. The interaction of the residue with the slag was evaluated by contacting a sample of the aforementioned mechanically pressed residue with a slag at the melting temperature of the slag.

US 2011/0239822A1 describes a method for producing a ferrous alloy in an EAF in which a physical mixture of a carbon-containing polymer (e.g. recovered tyre rubber) is used together with a second carbon source (e.g. coke). The physical mixture of the two materials is injected into the furnace both with the function as an auxiliary fuel and as a foamy slag forming agent.

U.S. Pat. No. 5,554,207A describes the combined use of a water-insoluble thermoplastic polymer with fine metal particulate matter in an oxygen-converter steel or EAF production process. The thermoplastic polymer is preferably a polymer coming from the recovery of post-consumer waste, while the metal particulate matter is obtained by filtration of the combustion fumes of the melting furnace. The two materials are combined together under heat, e.g. in an extruder, to form an agglomerated product in which the thermoplastic polymer acts as a binder of the metal particles. The agglomerated product, which is added to the used ferrous scrap charge, is then used as a vehicle to recover the metal values in the melting furnace and to exploit the thermoplastic material as fuel.

WO 2012/019216 describes the use of a composite product comprising thermoplastic material and a carbon-containing material in high temperature processes, including EAF furnace processes. As an alternative or in addition to the carbon-containing material, the composite product may contain a metal-containing material. In the examples, the composite material prepared by extrusion in the form of relatively high mass blocks, of the order of about 3 kg. The blocks can be used in a steelmaking process as an auxiliary fuel in addition to the scrap charge. Alternatively, the composite product can be used as a building material or protective material.

Irshad Mansuri et al., in “Recycling Carbonaceous Industrial/Commercial Waste as a Carbon Resource in Iron and Steelmaking”, Steel Research Int. 87 (2016) No. 9999 (DOI: 10.1002/srin.201600333), analysed the potential for reuse in EAF furnaces of waste plastics such as compact discs (polycarbonates), carbon fibre-reinforced polymers and bakelite. The document mentions the use of generic composite materials containing carbon from biochar instead of the conventional fossil carbon sources, without specifying the exact composition of the composites.

In Terry Norgate et al., “Biomass as a Source of Renewable Carbon for Iron and Steelmaking”, ISIJ International, Vol. 52 (2012), No. 8, pp. 1472-1481, cited by Irshad Mansuri et al., describes the use of direct-reduced composite materials formed from iron ore and biomass as blast furnace feed material in integrated cycle processes. The use of biomass as a substitute for fossil carbon sources in the foaming step of the slag in a EAF furnace is also described.

### SUMMARY OF THE INVENTION

In view of the above state of the art, the Applicant has faced the problem of overcoming one or more of the above drawbacks affecting the known methods for foaming the slag in an electric arc furnace. In particular, the Applicant set out to provide a method for producing a foamy slag effectively and, at the same time, having a reduced environmental impact. A further object is to provide a method for producing a foamy slag that is more easily achievable than prior art methods and, in particular, allows overcoming the drawbacks associated with the use of biochar as a foamy slag forming agent of the prior art.

The Applicant has now found that the above and other objects, which will be better illustrated in the following description, can be achieved by a method for forming a foamy slag in an EAF furnace during a process for producing a ferrous alloy—wherein the foaming of the slag is carried out by injection of a composite material in granular form comprising a thermoplastic polymer, which is preferably obtained from the recovery of post-consumer or post-industrial waste or products in plastic material, and a carbonaceous material of biogenic origin.

It has been observed that the aforementioned composite material, thanks to the relatively high density of its granules, is more easily injectable in the furnace than either the individual components or the combined injection of a physical mixture thereof, and is therefore able to penetrate deep into the slag and/or into the molten metal bath with consequent improved effectiveness of the slag foaming action.

The granular composite material, moreover, is less susceptible to entrainment in the combustion fume stream sucked in by the furnace collection system than its components used individually or in a non-aggregated form.

The use of the aforementioned composite material in granular form also makes it possible to simultaneously introduce into the EAF furnace a material having a high carbon and fixed carbon (char) content together with a material with a high content of volatile fraction and hydrogen (polymeric material, for example of polyolefinic type), which favours the reactivity towards the slag, due to both the intense mass exchange induced by the volatile fraction and the high reactivity of hydrogen, and the formation of small gaseous bubbles that have a stabilising effect on the structure of the foamy slag. The two materials (char and polymer) are also, thanks to agglomeration, in direct contact with each other, so as to favour the chemical interaction. This direct contact also favours the cracking of hydrocarbons (generated by the breakage of the polymer chains) due to the catalytic effect of the char, with consequent formation of solid carbon. Solid carbon can thus be deposited on the surface of the char itself, increasing its roughness thus its surface and wettability compared to the slag and the liquid metal. This also overcomes the problem associated with the low wettability of the biochar and thus its limited reactivity towards slag.

The use of the thermoplastic material and of the biogenic carbonaceous material in aggregate form of granules, moreover, allows to exploit the high surface area and the high porosity that characterizes biogenic carbonaceous materials, favouring the gasification reactions that take place at the solid-gas interface. In the state of the art, in fact, the porosity of the biogenic materials cannot be exploited effectively because its low density and thus part of the problems encountered in the furnace depend strictly on this porosity.

The use of the composite material in granular form then allows the control and optimisation of the surface/particle volume ratio, which, by acting on the heat exchange and reaction surfaces, influences the oxidative and volatilisation mechanisms of the material during the process of injection in the furnace and reaction within the slag.

The higher effectiveness of the composite material in the slag foaming process thus makes it possible to reduce the environmental impact of the production processes of ferrous alloys in electric arc furnaces, effectively reducing the emissions of climate-altering gases, in particular carbon dioxide from fossil sources, as well as the consumption of raw materials and energy.

The compactness of the composite material, its lower hygroscopicity, and its granular form also make the material movable and storable without generating significant diffuse emissions of fine particulate matter into the work environment and limit the risk of water incorporation during storage.

Moreover, since the composite material can be prepared in granules having variable shape and sizes in a wide size range, e.g. by hot extrusion of the thermoplastic and biogenic carbonaceous material, it can easily be prepared in the most suitable granule size for its injection into the furnace with the devices commonly used for the injection of fossil coal or biochar, avoiding, also thanks to the greater mechanical compactness, the clogging problems of such devices and of the pneumatic conveying systems associated with the fineness of the powders of these materials.

Therefore, according to a first aspect, the present invention concerns a method for forming a foamy slag in an electric arc melting furnace during the production of a ferrous alloy comprising the following steps:
a. melting a metal charge in the electric arc furnace to obtain a molten metal bath comprising a layer of a floating slag;
b. introducing a foamy slag forming agent into the furnace to foam said floating slag,
wherein said agent is a composite material in granular form which comprises at least one thermoplastic polymeric material and at least one biogenic carbonaceous material.

### DETAILED DESCRIPTION OF THE INVENTION

In accordance with the present invention, the foamy slag forming agent is a composite material in granular form comprising at least one thermoplastic polymeric material and at least one biogenic carbonaceous material.

For the purposes of this description and the accompanying claims, the term “composite material” means an agglomerated product comprising at least one thermoplastic polymeric material and at least one biogenic carbonaceous material, wherein the thermoplastic polymeric material acts as a binder of the biogenic carbonaceous material.

The thermoplastic polymeric material can be any polymeric material that is solid at room temperature, preferably substantially free of halogens (particularly fluorine and chlorine), suitable for acting as a binder of biogenic carbonaceous material so as to form a compact composite material in granular form. To this end, the polymeric material must be able to be transformed in a fluid polymeric phase by heating, for example at a temperature within the range of 100° C.-300° C., preferably within the range of 150° C.-250° C.

Preferably, the thermoplastic polymeric material comprises polyolefinic polymers. Preferably, the thermoplastic polymeric material comprises: polyethylene (PE), polypropylene (PP), polyethylene terephthalate (PET), polystyrene (PS) and mixtures thereof. Polyethylene can be either low-density polyethylene (LDPE) or high-density polyethylene (HDPE).

Thermoplastic polymeric material is preferably a recycled polymeric material, i.e. obtained from the recovery of waste products that have reached the end of their life cycle (so-called post-consumer recycled products) comprising a thermoplastic polymeric material or from waste from polymeric material production processes (so-called post-industrial recycled products). Preferably, the polymeric material is a material obtained at least partially from renewable sources, e.g. a bioplastic.

Examples of post-consumer recycled products from which a polymeric material suitable for the purposes of the present invention can be obtained are the products deriving from the separate collection of municipal waste (e.g. food films and packaging, vials, bottles, containers, etc.) or agricultural film waste and scrap. Examples of post-industrial recycled products are the waste from the production processes of the above-mentioned products. Before being used in a metallurgical production cycle, these products generally undergo one or more pre-treatments, such as sorting, washing, fragmentation, screening, densification and extrusion.

In one embodiment, the thermoplastic polymeric material is the fraction of material remaining at the end of the processes of treatment and sorting of plastics coming from the separate collection of municipal waste. This fraction is also known as Plasmix.

The use of Plasmix for the purposes of the present invention is particularly advantageous by virtue of its high availability and the fact that, in the state of the art, it is mainly intended for energy recovery by incineration and disposal in landfills.

The thermoplastic polymeric material to be used to prepare the composite material in granular form is typically in the form of flakes, powders or granules, even of very variable shape, having a maximum size within the range of 0.3 mm-40 mm.

The thermoplastic polymeric material preferably has a carbon content equal to or greater than 50% by weight, more preferably equal to or greater than 65% by weight with respect to the weight of the thermoplastic polymeric material. Preferably, the carbon content is within the range of 50%-90%, more preferably 70%-90%, with respect to the weight of the thermoplastic polymeric material.

The thermoplastic polymeric material preferably has a hydrogen content equal to or greater than 5% by weight, more preferably equal to or greater than 10% by weight with respect to the weight of the thermoplastic polymeric material. Preferably, the hydrogen content is within the range of 5%-15% with respect to the weight of the thermoplastic polymeric material.

Thermoplastic polymeric material, in particular that obtained from the recovery of waste, may contain impurities, such as metal elements (e.g. aluminium), dyes, pigments and other additives generally used for the production of the polymeric material or impurities formed from materials of other nature (e.g. sand).

The amount of thermoplastic polymeric material present in the composite material can vary over wide ranges and may be determined based on the need for use in the ferrous alloy production process. Preferably, the thermoplastic polymeric material is present in an amount within the range of 10%-90% by weight with respect to the weight of the composite material, more preferably within the range of 30%-70%.

For the purposes of the present invention, the biogenic carbonaceous material (hereinafter also referred to as “carbonaceous material”) is an organic carbon-containing material produced from animal or plant living beings. Preferably, the carbonaceous material is an organic material of plant origin. More preferably, the carbonaceous material is a char. Char is a product obtained by thermochemical conversion of a biomass in oxygen deficiency, e.g. by pyrolysis, torrefaction, steam explosion, gasification or hydrothermal carbonisation processes. These thermochemical conversion treatments of biomass make it possible to obtain a product with a high carbon content, in particular a high fixed carbon content, and a higher calorific value than untreated biomass. Preferably, the biogenic carbonaceous material is a “biochar”′, i.e. a char that has been produced by processes that are considered environmentally sustainable, e.g. involving exploitation of waste from the processing of biomass obtained from a correct management of forest resources.

The biogenic carbonaceous material preferably has a carbon content equal to or greater than 50% by weight, preferably equal to or greater than 60% by weight, more preferably equal to or greater than 75% by weight with respect to the weight of the carbonaceous material. Preferably, the carbon content is within the range of 50%-95%, more preferably 60%-95%, still more preferably 75%-90% with respect to the weight of the carbonaceous material.

The other elements present in the char are mainly, hydrogen, oxygen and sulphur.

In accordance with a preferred embodiment, the chemical composition of char is as follows (weight percentages referred to char weight, on a dry basis):

| | |
|---|---|
| 75%-90% | carbon, |
| 0.5%-4% | hydrogen, |
| 2%-8% | ash, |
| 5%-15% | oxygen, |
| 0%-3% | sulphur. |

An advantageous feature of char is its relatively low ash content compared to coal of fossil origin and coke. Ashes, in fact, can interfere with the oxide reduction mechanism as they form liquid or solid interfaces that hinder the contact among the reactants. In addition, ashes can locally modify the viscosities of the slag and thus the ability of the slag itself to retain the gaseous bubbles inside it to form a stable foam.

In a preferred embodiment, the char is obtained by a torrefaction or steam explosion process. Preferably, the torrefaction process comprises the heat treatment of the starting organic material in oxygen deficiency at a temperature of 200° C.-350° C. Since in torrefaction and steam explosion processes, the thermochemical conversion of the organic material is carried out at a relatively low temperature compared to pyrolysis, such processes have a significantly higher char production yield than pyrolysis or gasification (in torrefaction, up to 0.5-0.9 kg of char can be produced per kg of starting dry material). Torrefaction and steam explosion processes are also easier to implement, as they have a smaller volume of gaseous by-products to handle.

Compared to char from pyrolysis or gasification, char from torrefaction and steam explosion generally has a lower total carbon and fixed carbon content, a higher volatile fraction content, and a lower calorific value. In a preferred embodiment, the char has one or more of the following characteristics:
Total carbon (on a dry basis): 50-70%;
Fixed carbon (on a dry basis): 18-65%;
Volatile fraction (on a dry basis): 30-80%;
Calorific value: 19-30 MJ/kg.

Due to its characteristics, the char from torrefaction or steam explosion is a biogenic material that in the state of the art is not substantially used in the steel industry as it presents high safety problems due to its high flammability. When used in the composite material in accordance with the present invention, however, it can be advantageously exploited as a foamy slag forming agent. The present invention thus allows to expand the types of alternative carbon sources to the fossil carbon sources available today.

Generally, the biogenic carbonaceous material is in the form of flakes or powders or pellets, for example depending on the starting biomass and the preparation process (pyrolysis, torrefaction, etc.). The biogenic carbonaceous material may also be processed, for example by drying and/or grinding in order to obtain a size and a water content that are suitable for subsequent agglomeration with the polymer.

Typically, the biogenic carbonaceous material is used to prepare the composite material in the form of powders or flakes or pellets having a maximum size equal to the maximum of 15 mm, more preferably equal to the maximum of 10 mm, still more preferably equal to the maximum of 5 mm. Preferably, the maximum size of the powders or flakes is within the range of 1-10 mm, more preferably within the range of 2-5 mm.

When the biogenic carbonaceous material is obtained by torrefaction or steam explosion, it is generally commercially available in pellet form. The pellets can be used as they are to prepare the composite material according to this description. Preferably, the pellets have a maximum size equal to the maximum of 50 mm, more preferably equal to the maximum of 40 mm, still more preferably equal to the maximum of 20 mm. Preferably, the maximum size of the pellets is within the range of 1-50 mm, more preferably within the range of 1-40 mm, still more preferably within the range of 2-20 mm.

The amount of carbonaceous material present in the composite material can vary over wide ranges and may be selected based on the need for use in the ferrous alloy production process. Preferably, the carbonaceous material is present in an amount within the range of 10%-90% by weight with respect to the weight of the composite material, more preferably within the range of 30%-70%.

Preferably, the weight ratio of biogenic carbonaceous material to polymeric material is within the range of 0.1-9, preferably within the range of 0.4-2.4.

The composite material may also comprise one or more additives. Additives can be incorporated into the composite material in order to improve the performance of the granules for injection into the EAF furnace and/or to improve the granule production process. For example, lubricating additives, e.g. calcium stearate, can be added to improve the fluidity of the e polymer to facilitate the incorporation of char into the molten polymer. Steel-refining additives, such as quicklime, can be introduced to increase the basicity of the slag, or recycled rubber powder (e.g. obtained by grinding tyres) can be introduced to further promote slag foaming. It is also possible to use additives generally used in the production of polymeric materials, such as pigments, dyes, plasticisers, antioxidants and others. Additives may be present in the composite material in an amount within the range of 0-50% by weight, preferably, 0.1%-10% by weight, with respect to the weight of the composite material.

The composite material according to the present invention is in granular form. The term “granular” means that the components of the composite material are aggregated together to form subdivided units (granules). The granules can be very variable in shape and size. The granules may, for example, be in the form of pellets, compacts, cylinders, spheres or aggregates of other forms, even irregular one.

Preferably, the granules have a bulk density within the range of 200-1000 kg/m³ (ASTM D1895B), still more preferably within the range of 300-900 kg/m³.

Preferably, the granules have a maximum size equal to the maximum of 15 mm, more preferably equal to the maximum of 10 mm, still more preferably equal to the maximum of 5 mm. For the purposes of the present invention, this means that the granules can pass through a square-meshed sieve with sides, respectively, of 15 mm, preferably 10 mm, more preferably 5 mm.

Preferably, the granules have a maximum size equal to at least 1 mm, more preferably equal to at least 2 mm, still more preferably equal to at least 3 mm, still more preferably within the range of 1 mm-15 mm.

For the purposes of the present invention, the term “a maximum size” means a characteristic size of the granule, such as diameter, length, width or thickness, the extent of which is maximum with respect to the other sizes.

The composite material in granular form can be prepared using techniques known in the art, e.g. in the sector of the preparation of granules and agglomerates of polymeric materials.

In general, the preparation process comprises heating the thermoplastic polymeric material up to its melting temperature and then mixing it with the carbonaceous material to form a fluid homogeneous composite material, which is then cooled until solidification.

Alternatively, it is possible to prepare a homogeneous mixture of the two materials in a solid state and then subject the mixture to heating at a temperature high enough to melt the polymeric material and then form the fluid homogeneous composite material, which is then cooled until solidification.

In a preferred embodiment, the heating and mixing step of the two components is made in an extruder. In the extruder, the two components can be fed as a physical mixture or separately. In the latter case, the polymeric material is first heated in the extruder body and then mixed with the carbonaceous material, which can be introduced into the extruder through side inlets. The amalgamated composite material then escapes through the holes of the extrusion die where it is formed in the desired geometry (e.g. cylindrical shape) and then cooled (e.g. air or water) and cut into granules of the desired size.

Alternatively, other mixing/extrusion technologies such as continuous mixing can also be used.

In accordance with the present invention, the composite material in granular form can be used as a foamy slag forming agent in a process for producing a ferrous alloy in an electric arc furnace, both in discontinuous mode (conventional process with discontinuous feed of the metal charge) and in continuous mode (e.g. process with continuous feed of the preheated metal charge). For this purpose, the composite material is introduced into the EAF, during or after the melting phase of the metal charge, in the presence of the floating slag. The formation of the floating slag can be induced by introducing slag forming compounds into the furnace, such as quicklime, dolomite and magnesite, which may be loaded together with the metal charge to be melted or subsequently injected into the furnace during melting. The melting of the charge is generally also supported by injection of gaseous oxygen into the furnace.

The introduction of the composite material as a foamy slag forming agent can be carried out with the techniques and the devices known to the person skilled in the art. Preferably, the granular composite material is introduced into the EAF furnace by injection with one or more lances. The lances typically extend into the furnace through openings in the side walls or on the roof of the furnace. The lances generally use a gaseous stream (e.g. compressed air) to convey the granules.

Preferably, the composite material in granular form is dispersed in the floating slag layer and/or in the molten metal bath near the floating slag layer. Generally, this operation is carried out when the melting of the metal charge is at an advanced stage and/or when it is finished.

Once injected into the furnace, the granules of composite material come into contact with the slag, triggering multiple chemical reactions that lead to the foaming of the slag and simultaneously to the reduction of the iron oxide into liquid metallic iron. The reaction of the composite material in the slag takes place in two steps: in a first step, the fraction of polymeric material leads to an endothermic cracking process with prevalent formation of hydrocarbons, solid carbon, carbon monoxide and hydrogen that partly reduce the iron oxide; in a subsequent second step, the oxidation of carbon of biogenic origin occurs. The endothermic step helps cool the slag, increases its viscosity and promotes foam stabilisation.

Without wishing to refer to any particular theory, it is believed that, following the introduction of the granules into the furnace, the polymeric material is converted very quickly releasing the particles of carbonaceous material; the polymeric and the biogenic carbonaceous material therefore trigger different chemical reactions, as illustrated below.

In general, the chemical reactions between the carbonaceous material lead to the latter foaming are mainly as follows:

$$\overline{FeO} + {C}_{( s )} = {Fe}_{( l )} + {CO}_{( g )} \qquad ( 1 )$$

$$\overline{FeO} + {CO}_{( g )} = {Fe}_{( l )} + {CO}_{2} ( g ) \qquad ( 2 )$$

$${C}_{( s )} + {CO}_{{2}_{( g )}} = 2 {CO}_{( g )} \qquad ( 3 )$$

The carbonaceous material, in contact with the slag, reduces the iron oxide into metallic iron in a liquid state, simultaneously forming gaseous carbon monoxide (reaction 1). The particles of carbonaceous material are then enveloped by a gaseous surrounding of carbon monoxide which, on the surface of the slag, will continue the reducing action by means of which it will form carbon dioxide and further liquid metallic iron (reaction 2). Once formed, the carbon dioxide then diffuses in the gaseous surrounding towards the carbonaceous material particles, triggering a gasification reaction with the formation of carbon monoxide (reaction 3).

For the polymeric material, e.g. a polyolefin, the following reactions can be considered instead:

$$polimero \to {C}_{n} {H}_{{m}_{( g )}} \qquad ( 4 )$$

$${C}_{n} {H}_{m} = {n C}_{( s )} ( g ) + \frac{m}{2} {H}_{{2}_{( g )}} \qquad ( 5 )$$

$${C}_{n} {H}_{m} ( g ) + {n CO}_{{2}_{( g )}} = 2 {n CO}_{( g )} + \frac{m}{2} {H}_{{2}_{( g )}} \qquad ( 6 )$$

$$\overline{FeO} + {H}_{{2}_{( g )}} = {Fe}_{( l )} + {H}_{2} {O}_{( g )} \qquad ( 7 )$$

$$\overline{FeO} + \frac{1}{n} {C}_{n} {{H}_{m}}_{( g )} = {Fe}_{( l )} + {CO}_{( g )} + \frac{m}{2 n} {H}_{{2}_{( g )}} \qquad ( 8 )$$

$${C}_{( s )} + {H}_{2} {O}_{( g )} = {H}_{{2}_{( g )}} + {CO}_{( g )} \qquad ( 9 )$$

First, the polymer chains of the polymeric material break to form hydrocarbons and shorter hydrocarbon chains (reaction 4). These, in turn, decompose to yield carbon in solid form and hydrogen gas according to reaction 5. They can also react with carbon dioxide (reaction 6) or with iron oxide of the slag (reaction 8) to form carbon monoxide, hydrogen and, for the reaction with the slag, metallic iron.

Reactions 5, 6 and 8 have hydrogen as reaction product, which in turn acts as reducing agent. Based on reaction 7, hydrogen is capable of reducing iron oxide with faster reaction kinetics than carbon monoxide. This also favours the formation of numerous and small gaseous bubbles with a consequent stabilising effect on the foamy slag, since this facilitates the retention of the gaseous phase inside the slag. Reaction 7 also produces water, which, similarly to carbon dioxide, is able to gasify solid carbon according to reaction 9 with the formation of hydrogen and carbon monoxide.

When the biogenic carbonaceous material has a relatively high content of volatile fraction, such as in the case of biochar by torrefaction, this will release a significant amount of gaseous chemical species, which also contribute to the mechanisms of slag foaming and iron oxide reduction.

The operational phases of the ferrous alloy production process that precede and follow the foaming phase of the floating slag are conventional operations, performed in accordance with the known technique.

Initially, for example, the metal charge to be melted may be introduced into the furnace by means of one or more loading operations, possibly interspersed with intermediate melting steps. Alternatively, the metal charge can be fed into the furnace in continuous mode after preheating, as is known in the art.

Once the chemical composition of the molten metal bath and its temperature have been optimised, the molten ferrous alloy metal is drawn from the furnace, separating it from the slag. The ferrous alloy thus obtained is then sent for further processings to transform it into the final finished product.

The following examples are provided purely for illustrative purposes of the present invention and are not to be considered as a limitation of the scope of protection defined by the appended claims.

In the examples, reference will also be made to the accompanying figures wherein:

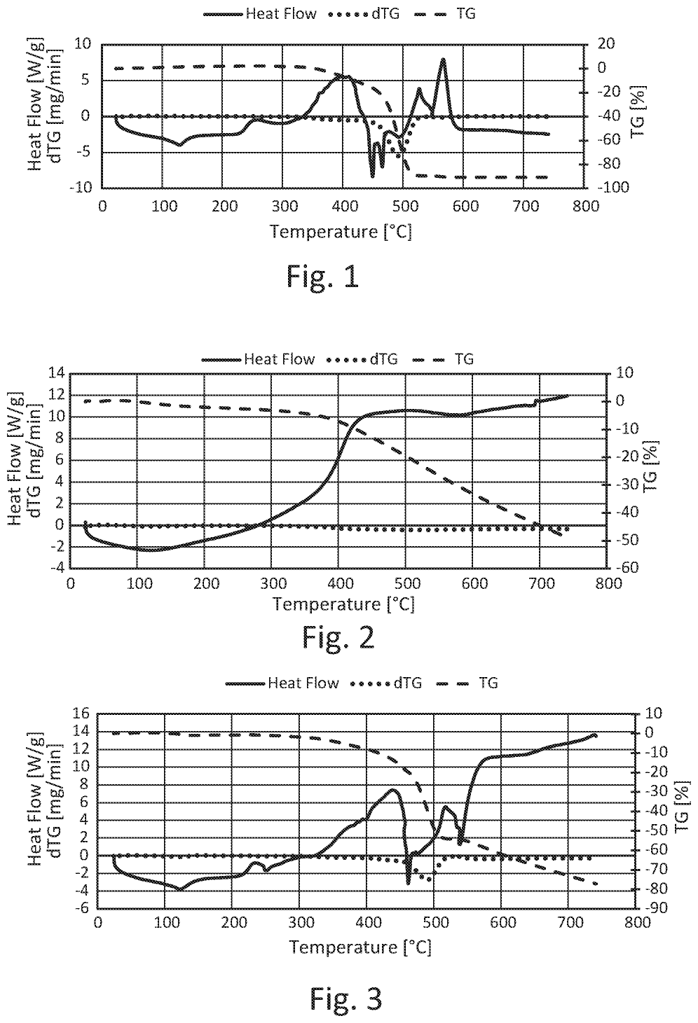

FIG. 1 shows the results of the thermogravimetric analysis of a polymeric waste material consisting mainly of LDPE;

FIG. 2 shows the results of the thermogravimetric analysis of a biochar produced by gasification;

FIG. 3 shows the results of the thermogravimetric analysis of a composite material according to this description comprising the polymeric material of FIG. 1 and the biochar of FIG. 2, in a mass ratio of 40:60 on a dry basis.

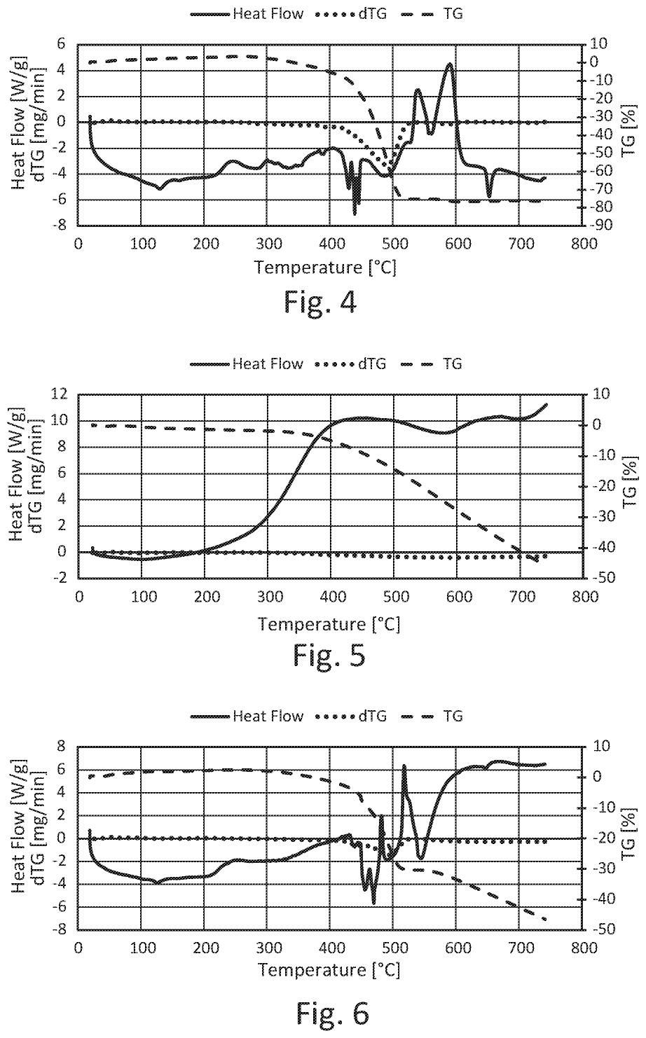

FIG. 4 shows the results of the thermogravimetric analysis of a polymeric waste material consisting mainly of LDPE and HDPE;

FIG. 5 shows the results of the thermogravimetric analysis of a biochar produced by pyrolysis;

FIG. 6 shows the results of the thermogravimetric analysis of a composite material according to this description comprising the polymeric material of FIG. 4 and the biochar of FIG. 5, in a mass ratio of 45:55 on a dry basis.

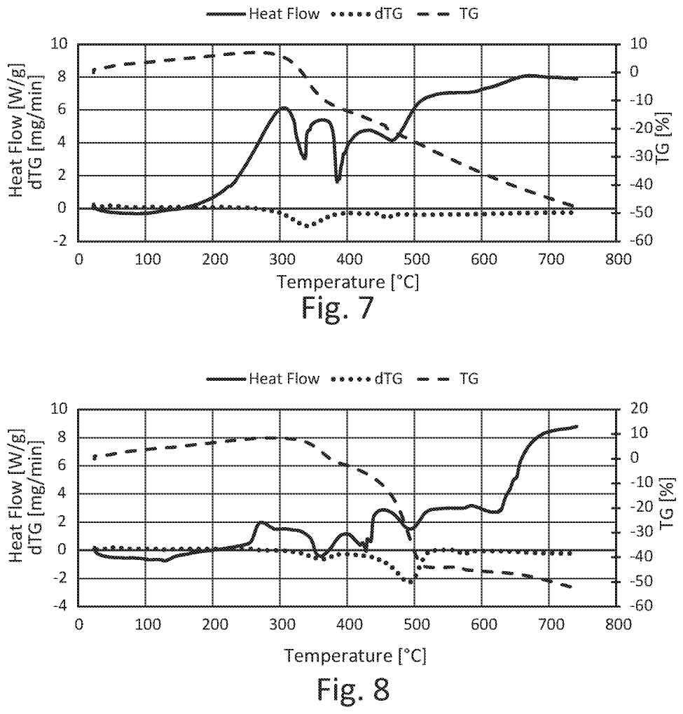

FIG. 7 shows the results of the thermogravimetric analysis of a biochar produced by torrefaction;

FIG. 8 shows the results of the thermogravimetric analysis of a composite material according to this description comprising the polymeric material of FIG. 4 and the biochar of FIG. 7, in a mass ratio of 50:50 on a dry basis.

### EXAMPLES

### Example 1

A foamy slag forming agent in accordance with the present invention has been prepared as follows.

In a twin-screw extruder it was fed as follows:
60 kg of polymeric material (90% w/w LDPE) coming from waste;
40 kg of biochar.

The biochar by gasification had the following composition: carbon greater than 70%, ash less than 6% and moisture less than 8%. The biochar was in the form of flakes or powder with a maximum size of 5 mm and mainly (at least 50% by weight) with a maximum size of less than 2 mm.

Inside the extruder, the polymeric material was melted at a temperature of about 190° C. and subsequently mixed with the biochar fed at three points placed sequentially along the side walls of the extruder. The two materials were thus agglomerated with simultaneous crushing of the biochar and evaporation of the water. Finally, the agglomerate was extruded through a die of circular cross-section with a diameter of 4 mm.

The extruded composite material was cooled and then cut into cylindrical shaped granules of 3-4 mm in length.

The granular composite material was found to have the following characteristics:
Bulk density: 420 kg/m³
Water content by weight: 1.2%.

The granules also showed satisfactory mechanical compactness.

The effectiveness of the granular composite material was evaluated by thermogravimetric analysis (sample 11.5 grams, heating from 25° C. to 750° C., heating rate equal to 25° C./min).

FIGS. 1-3 report the curves of percentage weight loss (TG %), released heat (Heat Flow) and mass variation rate (dTG) recorded for: polymeric material (FIG. 1), biochar (FIG. 2), granular composite material (FIG. 3). A comparison of FIGS. 1-3 shows that the mass loss curve of the composite material (FIG. 3) is given approximately by the superposition of the curves of the polymeric material (FIG. 1) and of the biochar (FIG. 2).

In FIG. 3, within the range of 300° C.-400° C. there is a weight loss from −2% to −8%; within the range of 400° C.-500° C. there is a vigorous decomposition of the polymer, reaching a weight loss equal to about −48%. Within the range of 500° C.-550° C., similar to what happens for the non-agglomerated polymeric material (FIG. 1), volatilisation slows down and then returns to grow and proceed, as is the case with the biochar (FIG. 2), almost linearly. At 750° C., combustion is not yet complete and 23% of the initial mass is still present.

The heat flow of the composite material (FIG. 3) shows a first endothermic peak at around 125° C. corresponding to the melting of the thermoplastic polymer (see FIG. 1) and a further endothermic peak within the range of 450° C.-500° C. which can be associated with the decomposition of the polymer and its volatilisation (see FIG. 1). Within the range of 500-600° C. in FIG. 1, exothermic peaks that can be associated with the combustion of the gases generated by the volatilization of the polymer are observed, also visible in FIG. 3 relating to the composite material.

Overall, the thermal analysis shows how the endothermic decomposition of the polymer limits the release of thermal energy due to the oxidation of the biochar. This behaviour facilitates the mechanism of injection of the composite material into the furnace, reducing the loss of material attributable to the combustion and volatilization of the biochar generally observed when trying to use the biochar in pure, non-aggregated form.

The thermal analysis indicates that the polymer fraction, by absorbing energy during its melting and decomposition, cools the slag by increasing its viscosity and, consequently, its ability to retain the gaseous bubbles necessary for foaming. The gases released by the polymer, mainly between 400° C. and 500° C., can thus effectively perform the reducing action. In addition, thanks to the initial thermo-oxidative protection performed by the polymer, the volatile fraction of the biochar can contribute to foam formation and to the reduction of oxides in the slag. Subsequently, at higher temperatures, the significant fraction of residual solid carbon, whose presence is evidenced in the thermal analyses by the stabilisation of the heat flow that can be observed starting from a temperature of around 600° C., can also act as a reducing g or recarburising agent. The reducing and recarburising action is also favoured by the intense mass exchange attributable to the substantial release of gases by the granules of composite material.

### Example 2

A second foamy slag forming agent in accordance with the present invention was prepared as described in Example 1 starting from the following materials:
polymeric material from post-consumer waste consisting of LDPE and HDPE (approx. 82% by mass; remainder foreign material);
commercial biochar, obtained by pyrolysis of woody biomass.

The polymeric material was in the form of granules.

The biochar, in the form of pellets and powder, had the following characteristics:
Fixed carbon (on a dry basis): >90%
Volatile fraction (on a dry basis): 3%-7%
Ash content (on a dry basis): <3%
Water content: approx. 1%
Calorific value: 34 MJ/kg
Bulk density: approx. 400 kg/m3

The composite material was prepared with polymeric material and biochar in a mass ratio of 45:55 on a dry basis.

The composite material was extruded into cylindrical-lentil-shaped granules having a diameter of about 5 mm, maximum thickness equal to about 3.6 mm and a bulk density equal to about 610 kg/m3.

The granular composite material had the following characteristics:
Lower calorific value (on a dry basis): 37 MJ/kg;
Water content by weight: <1%.

The effectiveness of the granular composite material s evaluated by thermogravimetric analysis (sample 11.5 grams, heating from 25° C. to 750° C., heating rate equal to 25° C./min).

FIGS. 4-6 report the curves of percentage weight loss (TG %), released heat (Heat Flow) and mass variation rate (dTG) recorded for: polymeric material (FIG. 4), biochar (FIG. 5), granular composite material (FIG. 6).

In FIG. 6, the mass loss trend is similar to that of the composite described above (Example 1, FIG. 3). The fastest mass loss occurs when passing from 400° C. to 500° C., moving from −1% to −25%. The subsequent slow oxidative mechanisms then lead to a mass loss of 46% when 750° C. is reached.

The residual solid fraction is considerably greater than the composite material of FIG. 3 (54% vs. 23%) but this is attributable to the higher biochar content and the higher solid residue of the polymer fraction (FIG. 4).

The thermal flow of this composite, when compared with those of the composite of FIG. 3, shows negative values up to 400° C., whereas in the case of FIG. 3 they became positive above 300° C. Although the same succession of endothermic reactions occurs around 450° C., for the composite in Example 2 (FIG. 4) two important energy release peaks at 480° C. and near 520° C. can be highlighted. The trend of the curve above 550° C. is instead similar to that of the composite of Example 1 containing the biochar from gasification of FIG. 2 and the polymeric material of FIG. 1 but with values of the thermal flow equal to half of those of the previous case.

The composite material of Example 2 was also tested in the steel mills, where several advantages over the separate use of thermoplastic polymers and biocarbon in accordance with the prior art were confirmed. In particular, the composite material according to the present invention completely replaced the anthracite used (substitution weight ratio composite material:anthracite equal to 1:1) for foaming the slag in a steel production cycle in an EAF furnace. The quality of the foamy slag obtained with the composite material was found to be completely comparable to that obtainable with anthracite (excellent coverage of the electric arc). During the cycle, no anomalies were observed in terms of the development of flames, excessive rise in the temperature of the fumes and the cooled panels of the furnace.

In terms of CO₂ emissions, considering the carbon content of anthracite (92% by weight), this has a CO₂ development equal to 3.37 CO₂/Kg anthracite used.

The use of the composite material according to Example 2 in substitution of anthracite (1:1 substitution ratio) resulted in a saving of CO₂ emissions equal to 66%.

### Example 3

A third foamy slag forming agent in accordance with the present invention was prepared as described in Example 1 and 2 starting from the following materials:
polymeric material from post-consumer waste consisting of LDPE and HDPE (approx. 82% by mass; remainder foreign material);
commercial biochar, obtained by torrefaction of woody biomass.

The polymeric material was in the form of granules.

The biochar, in the form of powder, had the following characteristics:
Carbon content (on a dry, ash-free basis): 60%-70%
Fixed carbon (on a dry, ash-free basis): 35%-45%
Volatile fraction (on a dry, ash-free basis): 55%-65%
Ash content: <4%
Water content: <3%
Calorific value: 21.5-23.5 MJ/kg
Bulk density: approx. 225 kg/m3.

The composite material was prepared with polymeric material and biochar in a mass ratio of 50:50 on a dry basis.

The composite material was extruded into cylindrical-lentil-shaped granules having a diameter of about 7 mm, maximum thickness equal to about 4.5 mm and an bulk density equal to about 420 kg/m3.

The granular composite material had the following characteristics:
Lower calorific value (on a dry basis): 32 MJ/kg;
Water content by weight: approx. 1%.

The effectiveness of the granular composite material was evaluated by thermogravimetric analysis (sample 11.5 grams, heating from 25° C. to 750° C., heating rate equal to 25° C./min).

FIGS. 4, 7 and 8 report the curves of percentage weight loss (TG %), released heat (Heat Flow) and mass variation rate (dTG) recorded for: polymeric material (FIG. 4), biochar (FIG. 7), granular composite material (FIG. 8).

In FIG. 8, the composite material exhibited a complex behaviour, mirroring what was highlighted for biocarbon by torrefaction in pure form (FIG. 7).

The composite material first has a mass growth up to about 300° C. (+8%). Subsequently, there is a mass decrease that brings the sample to −3% at 400° C. From 400° C. to 500° C. the mass loss is significant, both due to the decomposition of the polymer fraction and the devolatilization and oxidation of the biochar. At 500° C. the residual mass is 63%. Finally, once 750° C. is reached, there is a residual fraction of 47%. Combustion does not reach completion during the test.

The trend of the thermal flow suggests that the endothermicity of the polymer decomposition reaction dampens the exothermic action associated with biochar oxidation. Between 200° C. and 500° C., a complex behaviour occurs with a succession of less pronounced and localised peaks and valleys than what was found in the composites of Examples 1 and 2 (FIGS. 3 and 6). Above 520° C., the flow stabilises up to about 620° C. and then increases and tends to stabilise around 700° C.

Also the composite material of Example 3 was tested in the steel mills, where several advantages over the separate use of thermoplastic polymers and biocarbon were confirmed in accordance with the prior art. In particular, the composite material according to the present invention completely replaced the anthracite used (substitution weight ratio composite material:anthracite equal to 1:1) for foaming the slag in a steel production cycle in an EAF furnace. The quality of the foamy slag obtained with the composite material was found to be completely comparable to that obtainable with anthracite (excellent coverage of the electric arc). During the cycle, no anomalies were observed in terms of the development of flames, excessive rise in the temperature of the fumes and the cooled panels of the furnace.

In terms of CO₂ emissions, considering the carbon content of anthracite (92% by weight), this has a CO₂ development equal to 3.37 CO₂/Kg anthracite used.

The use of the composite material according to Example 3 in substitution of anthracite (1:1 substitution ratio) resulted in a saving of CO₂ emissions equal to 62%.

Overall, the tests conducted in steel mills with the composite materials described in the Examples confirmed several advantages of the present invention:
the density of the composite materials, although lower than that of anthracite (about 900 kg/m3), is up to three times higher than that of biochar in pulverulent form. This implies fewer trucks to transport the material to the steel mill, resulting in reductions in pollutant emissions and costs linked with logistics. The steel site is also less congested in terms of handling the incoming materials;
the composite material, unlike biochar, does not suffer from hygroscopicity problems, thus facilitating storage over long periods of time. From a safety point of view, the agglomeration of the biochar with the polymeric material results in mechanically solid granules, thus solving the problem of the presence of abundant fine, flammable and explosive powder in the work environment, which characterises biochar. For example, the transfer of material from big bags inside the silos for injection into the furnace did not show any perceptible release of powder into the environment. This is also an improvement on normal practices concerning anthracite. Agglomeration solves the problem of reactivity of the biochar towards air. Due to this reactivity, biochar is subject to risks of self-ignition if stored in large volumes for prolonged periods of time, and is a material can be easily triggered. Dispersing and trapping the biochar within the polymer matrix thus results in the minimisation of any risk at the steel site;
thanks to their physical form, the granules of composite material are particularly suitable for pneumatic transport from the pressurised tank to the injection lances in the furnace. The granules exhibit excellent flowability, allowing precise flow regulation. This aspect translates into the possibility of optimally controlling the injection process with consequent positive impacts in terms of energy consumption and emissions. Thanks to agglomeration, the composite material solves the problem of the propensity of the biochar to form powdery fractions of various particle sizes. In fact, these fractions tend to pack, particularly in the presence of bends or narrowings in the ducts, making it difficult to control the flow rate of their supply;
in light of the lower bulk density than anthracite, as would be the case for pure biochar, the granules of composite material according to the present invention also generally require an adaptation of the injection lances. Such modifications may concern the injection angle, or the adoption of a secondary entrainment flow (e.g. oxygen jet) to allow an effective penetration of the slag material, and are in any case easily manageable by the person skilled in the art. Compared to biochar, composite granules have a higher density, reducing the problems associated with the ability of the material to penetrate slag. Furthermore, the almost total absence of a powdery phase, which characterises both anthracite and biochar, limits the loss of material due to the entrainment of these fine particles in the gases rising from the bath. Such particles may then be wasted due to their propensity to oxidise or volatilise before reaching the slag. From this point of view, extrusion allows the control of the surface/volume ratio of the particles, which impacts both the heat exchange mechanisms to which the granules are subjected during injection into the furnace, and the reacting surfaces of the particles. By controlling the sizes of the granules, it was therefore possible to optimise the effectiveness of the material with respect to injection: granules that are too fine, in addition to possible difficulties in penetrating the slag, tend to rise rapidly in temperature with a rapid release of the volatile fraction or a rapid oxidation; granules that are too large, on the other hand, show a tendency to float on the slag, contributing only partially to the mechanisms of iron oxide reduction and foamy slag formation. The indication that the benefits expected from a theoretical point of view have materialised in the practical application can be seen in the fact that replacing anthracite with granules of composite material as a foamy slag forming agent did not lead to any anomalies in the furnace. In particular, there were no higher flames than usual and the temperatures of both the cooled panels and the exhaust fumes remained within the historical range. The fact that both the granules produced with biocarbon both by pyrolysis and torrefaction worked also indicates that the polymer effectively protected the biocarbon thermo-oxidatively. In this way, surprisingly, the biocarbon by torrefaction was also able to reach the slag, releasing its substantial volatile fraction inside it, which exerted its reducing action;
the granules of composite material are agglomerates having a uniform composition of biochar and polymer. This maximises the interaction between biochar and polymer, already in perfect physical contact with each other, and the slag. In addition to providing thermo-oxidative protection to the biochar as described for the injection process, the polymer solves the problems of low reactivity with the slag in connection with the biogenic carbonaceous material. In fact, the problems of the biochar used in the prior art seem to be attributable to the presence of smooth surfaces at the nanometer and micrometer level, which would favour the formation of stable gaseous stratifications and thus be capable of stopping the reducing action of the biochar towards the slag. Instead, it is assumed that the abundance of hydrogen and the intense mass exchange associated with the polymer fraction accelerates the kinetics of the reduction process, particularly in the presence of solid carbon such as that provided by the biochar. In addition, the possibility that hydrocarbon species due to the polymer fraction can interact with solid carbon, pyrolysing and forming carbon deposits on the surfaces of the latter, can further facilitate the resolution of the problems associated with the biochar. The fact that the granules of composite material were able to completely replace anthracite in the tests conducted suggests that one or more of the mechanisms described above did indeed take place. The composite material also showed similar effectiveness to that of anthracite in terms of foamy slag quality (excellent arc coverage) and injected mass. This suggests that despite the different chemical-physical behaviour compared to fossil coal, even in the presence of the composite material, gaseous bubbles are formed that can generate a stable foamy slag.

1. A method for forming a foamy slag in an electric arc melting furnace during production of a ferrous alloy, the method comprising:
(a) melting a metal charge in the electric arc melting furnace to obtain a molten metal bath comprising a layer of a floating slag;
(b) introducing a foamy slag forming agent into the furnace to foam the floating slag,
wherein the agent is a composite material in granular form which comprises a thermoplastic polymeric material and a biogenic carbonaceous material.

2. The method of claim 1, wherein the thermoplastic polymeric material is obtained from post-consumer product waste recovery and/or recovery of industrial process waste comprising a polymeric material.

3. The method of claim 1, wherein the thermoplastic polymeric material comprises:
polyethylene,
polypropylene,
polyethylene terephthalate, and/or
polystyrene.

4. The method of claim 1, wherein the biogenic carbonaceous material is a char.

5. The method of claim 4, wherein the char is obtained by a process comprising gasification, pyrolysis, torrefaction, hydrothermal carbonization, or steam explosion.

6. The method of claim 1, wherein the thermoplastic polymeric material is present in an amount in a range of from 10 to 90 wt. % with respect to composite material weight.

7. The method of claim 1, wherein the biogenic carbonaceous material is present in an amount in a range of from 10 to 90 wt. % with respect to material weight.

8. The method of claim 1, wherein the biogenic carbonaceous material has a carbon content equal to or greater than 50 wt. %.

9. The method of claim 1, wherein the biogenic carbonaceous material has:
a total carbon on a dry basis in a range of from 50 to 70%;
a fixed carbon on a dry basis in a range of from 18 to 65%;
a volatile fraction on a dry basis in a range of from 30 to 80%; and/or
a calorific value in a range of from 19 to 30 MJ/kg.

10. The method of claim 1, wherein a weight ratio of the biogenic carbonaceous material to polymeric material is in a range of from 0.1 to 9.

11. The method of claim 1, wherein the thermoplastic polymeric material has a carbon content equal to or greater than 50 wt. %.

12. The method of claim 1, wherein granules of the foamy slag forming agent have a maximum size of 15 mm.

13. The method of claim 1, wherein granules of the foamy slag forming agent have a maximum size equal to at least 1 mm.

14. The method of claim 1, wherein the introducing (b) comprises dispersing the composite material in granular form in the layer of floating slag and/or in the molten metal bath in proximity to the layer of floating slag.

15. The method of claim 1, wherein the biogenic carbonaceous material comprises a biochar.

16. The method of claim 4, wherein the char is obtained by a process comprising torrefaction or steam explosion.

17. The method of claim 1, wherein the thermoplastic polymeric material is present in an amount in a range of from 30 to 70 wt. % with respect to composite material weight.

18. The method of claim 1, wherein the carbonaceous material is present in an amount in a range of from 30 to 70 wt. % with respect to composite material weight.

19. The method of claim 1, wherein the biogenic carbonaceous material has a carbon content in a range of from 50 to 95 wt. %.
